(19) United States
(12) Patent Application Publication
(10) Pub. No.: US 2014/0244405 A1
(43) Pub. Date: Aug. 28, 2014

(54) Automatic Generation of Digital Advertisements

(71) Applicant: ONESPOT, INC., Austin, TX (US)

(72) Inventors: Nathan Matthew COHEN, Austin, TX (US); Ian John Cecil Clarke, Austin, TX (US); Brendan Considine, Bethlehem, NH (US)

(73) Assignee: OneSpot, Inc., Austin, TX (US)

(21) Appl. No.: 13/780,501

(22) Filed: Feb. 28, 2013

(51) Int. Cl. G06Q 30/02

(52) U.S. Cl. CPC G06Q 30/0276
USPC 705/14.72

(57) ABSTRACT

In the disclosed embodiments, a method for automatically generating a digital advertisement includes receiving a source uniform resource locator (URL) and retrieving a document associated with the source URL. The method also includes processing the document associated with the source URL to derive at least a length of text associated with the document. The method also includes automatically generating a digital advertisement from at least the length of text.

### BACKGROUND

Traditional online advertising uses a cost-per-click model to drive viewers through a banner advertisement to an advertiser website. The banner advertisement is typically representative of the product or service being advertised and sold. Thus, traditional online advertising represents simply an online version of traditional print advertising.

Online users (or viewers) do not typically respond to traditional advertising placed online the same way they do to traditional print advertising due to the ever-changing nature of the online viewer experience. Most traditional online banner advertisements are simply ignored. Nevertheless, online advertisers generally treat the online environment the same way that print advertisers treat the print environment.

What is needed are systems and methods for the automatic generation of online advertisements that engage the user and generate interest in the product or service being sold.

### BRIEF DESCRIPTION OF THE DRAWINGS

Accordingly, there are disclosed herein content based promotional techniques with online components. In the drawings:

FIG. 1 is a block diagram of a system of networked entities;

FIG. 2 shows a method for providing web pages with advertisements using the system of FIG. 1;

FIG. 3 shows a block diagram of a networked computer system;

FIG. 4 shows features of an illustrative self-service user interface to generate digital advertisements;

FIG. 5 shows an illustrative computer system;

FIG. 6 shows an illustrative client device;

FIG. 7 shows an illustrative server device;

FIG. 8 shows a flowchart for a digital advertisement generation method; and

FIG. 9 shows a block diagram of a computer system.

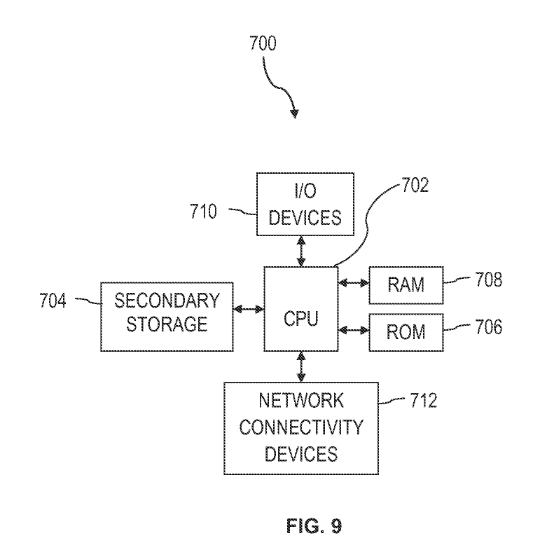

It should be understood, however, that the specific embodiments given in the drawings and detailed description thereof do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

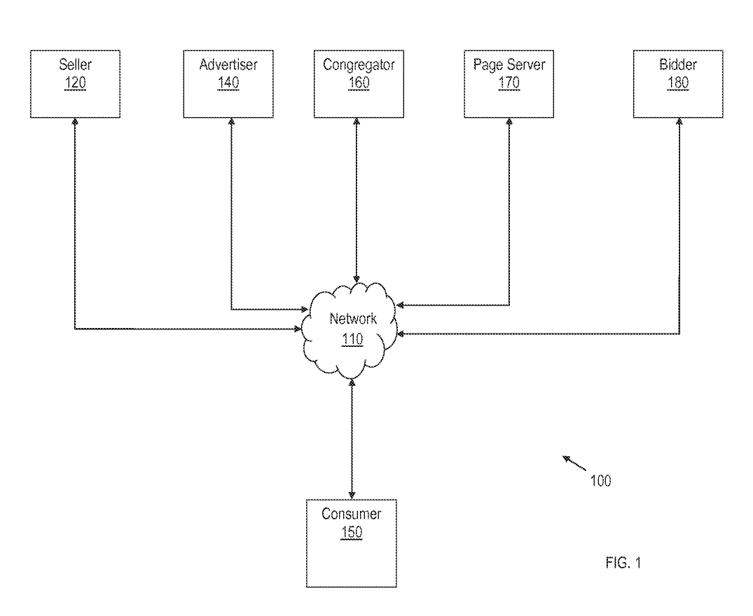

FIG. 1 shows a block diagram for a system 100 of networked entities related to generating digital or online advertisements as described herein. In the system 100, the Internet 110 connects a plurality of entities to each other. In other words, the respective server computers and client computers for the entities are able to communicate with each other as described herein. As used herein, the Internet 110 is broadly defined as one or more networks configured to exchange information between and/or among computing devices. In FIG. 1, the system 100 includes a seller 120 interested in promoting one or more goods and/or services to one or more consumers 150. The system 100 also includes an advertiser 140 that works with an advertising congregator 160 and a bidder 180 to provide one or more advertisements to a page server 170 to show to the user 150 when the user 150 requests a particular page over the Internet 110. Note that although only one of each is illustrated, it is understood that there are a plurality of each seller 120, consumer 150, advertiser 140, advertising congregator 160, bidder 180, and page server 170 connected to the Internet 110. Further, it should be understood that two or more of the entities shown in system 100 could be combined. For example, the congregator 160 and bidder 180 could be one entity, or the advertiser 140 and the bidder 180 could be one entity, and so on.

As will be described in more detail below, the advertiser 140 uses a piece of content 130 available through the Internet 110 to create a specific advertisement en on behalf of the seller 120. The advertiser 140 informs the bidder 180 how much to bid on a particular page view generated by the page server 170 to the consumer 150.

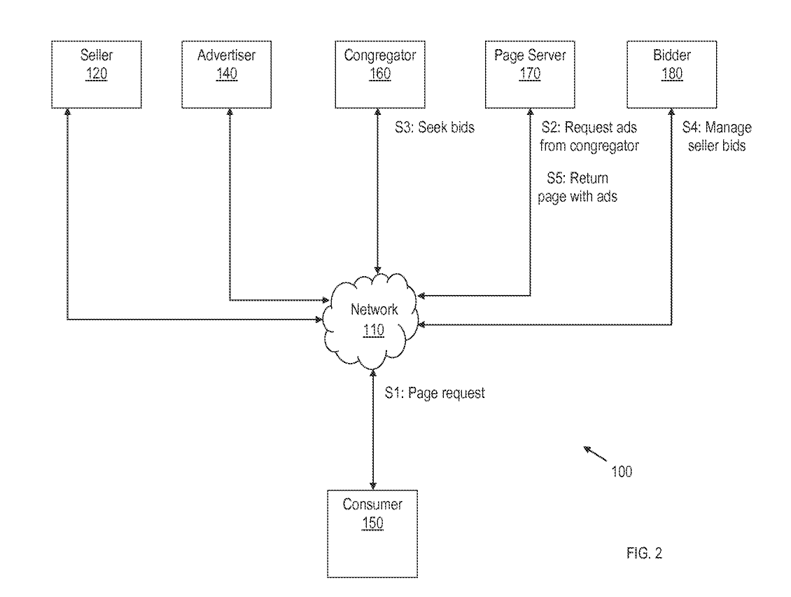

In FIG. 2, an illustrative method (steps 1-5) for providing web pages with advertisements using system 100. In response to a page request of the page server 170 by the user (step 1), the page server 170 requests one or more digital advertisements from the advertisement congregator 160 (step 2). To facilitate bids for the placement of a digital advertisement, the page server 170 includes identifying information about the consumer 150 and/or the user's computer or browser. This information may include the address of the requested page, the IP address of the user's computer, the browser type of the user's computer, the operating system of the user's computer any or certain cookies or other identifying files set in the user's browser cache or on the user's computer, etc. in turn, the advertisement congregator 160 seeks bids for placing the one or more digital advertisements into the page as it is sent to the consumer 150 (step 3). The advertisement congregator 160 provides all or some of the identifying information about the user, and/or the user's computer or browser, to the bidder 180.

The bidder 180 bids for each impression of the digital advertisement (step 4). In practice, the bidder 180 is bidding for a plurality of different sellers 120 and/or creatives from one or more sellers 120. The bidder 180 typically bids on thousands (or more) of impressions per second on a continual basis. Typically, the second-bid price auction is currently used for online advertising, although any reasonable bidding system could be used. Once the bid process is completed, the page server 170 returns the requested page to the consumer 150 with bid-based advertisements added to the page.

In at least some embodiments, any given seller may use the services of one or more advertisers 140 to generate online advertisements through one or more advertisement congregators 160 with the services of one or more bidders 180. Further, in some embodiments, the advertiser 140 also acts as the bidder 180.

Bidding for any given impression on any given page is a complex decision that is made in a fraction of a second, so the complete page, including one or more digital advertisements, can be delivered to the user as quickly and smoothly as possible. When possible, the seller 120 prefers to present ads to those consumers 150 who are most likely to click-through the digital advertisement and then perform an additional action after the click, such as moving from the content page to the seller's page or other action. Other additional actions may include subscribing to a newsletter provided by the seller or purchasing the seller's goods or services.

Thus, knowing who to target with advertisements is a key to cost-effective advertising. One way to increase the probability of actions after the click is to pre-target online advertising to those users most likely to click on an online advertisement in the first place. Because users are more likely to engage content instead of traditional advertising, the seller (prefers to segment the online population and engage the most likely buyers of the seller's goods and services. A sales conversion from interest to knowledge and then to purchase may be based on interest in the content tied to the seller's goods and services. Thus, a seller may only or preferentially provide content-based advertising to the target audience.

To generate digital advertisements from content articles, at least some of the disclosed embodiments employ an intelligent content scraper. The intelligent content scraper may be employed, for example, by self-service advertisers to automatically generate digital advertisements that may be used in online advertising or offline advertising. Further, the intelligent content scraper may gather publically available social media information for digital advertisements to generate interest in the mind of viewers by showing proof of social acceptance of the content. For example, “500 Facebook likes” or “retweeted 200 times” or “You have 5 friends who like this”. Once digital advertisements are generated, they may be uploaded to the advertisement congregator 160, along with a budget.

In some embodiments, the intelligent content scraper identifies the key features of content relative to one or more consumers for purposes of valuing each impression. For example, repeated words on the page to be served correlate to repeated words in the content used to generate a digital advertisement. A higher weight may be given to words in the headers, in tags, or in bold. Another example would be to bid higher for an impression on pages closer to the topic of the content. Examples of methodologies for identifying the correlation between the page to be served with the digital advertisement and the content used to create the digital advertisement include a Bayesian bag of words, similar to a spam filter, known related words, learned correlated words, and Wikipedia categories.

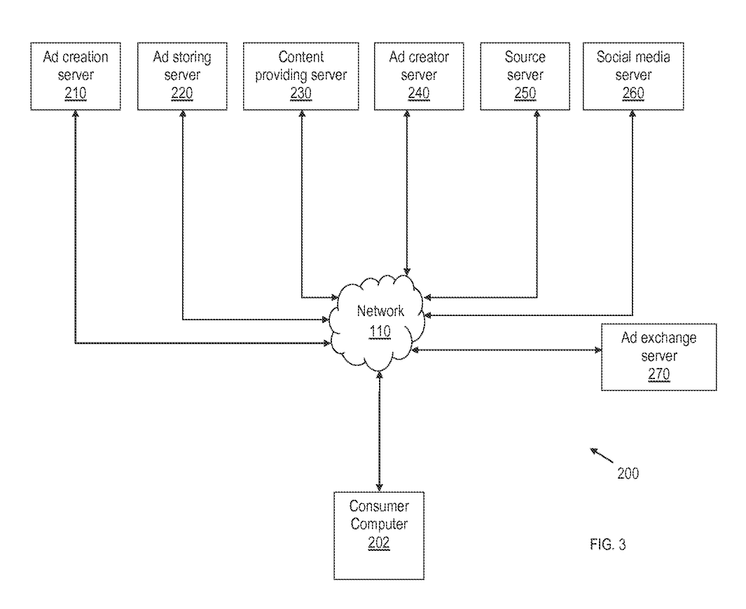

FIG. 3 shows a block diagram of a networked computer system 200 of networked computers. With the networked computer system 200, digital advertisements may be automatically generated as described herein. As shown, the networked computer system 200 includes an ad creation server 210, an ad storing server 220, a content providing server 230, an ad creator server 240, a source server 250, a social media server 260, an ad exchange server 270, and a consumer computer 202. The different servers described for system 200 may be owned by a single entity or different entities. Further, in some embodiments, the functionality of different servers described for system 200 may be combined.

In at least some embodiments, the ad creation server 210 operates to automatically create a digital advertisement based on a source document. The ad storing server 220 operates to provide an indication of a created digital advertisement in response to a request for at least one digital advertisement. The content providing server 230 operates to store a page configured to be requested over a network, where the page includes a location for integrating a display of a selected digital ad in response to a request for the page over the network. The ad storing server 220 also operates to provide the indication of the at least one digital advertisement in response to the request for the page.

In some embodiments, the ad creator server 240 operates to transmit a source uniform source locator (URL) for a source document to the ad creation server 210. Further, the source server 250 operates to transmit the source document to the ad creation server 210 in response to receiving a request at the source URL. Further, the social media server 260 operates to transmit an indication of social media popularity for a source page in response to a request from the ad creation server 210. Meanwhile, the ad exchange server 270 operates to select a winning digital advertisement and transmit the winning digital advertisement as the selected digital ad in response to the request for the page.

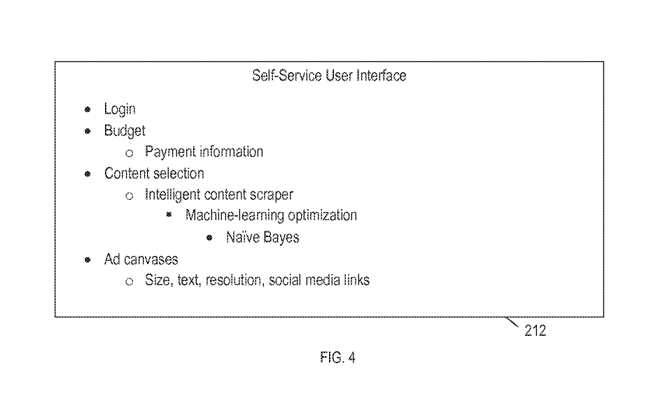

FIG. 4 shows features of a self-service user interface 212 to generate digital or online promotions. In at least some embodiments, the self-service user interface 212 includes a login feature. After login is complete, a user (e.g., a seller) is able to access a budget feature, a content selection feature, and an ad canvases feature. With the features, a user is able to generate and select digital advertisements, and provide a budget related to the selected digital advertisements.

As an example, a seller 120 may log into the self-service user interface 200 using a secure user name and password, or other login mechanism, as is known in the art. After a successful login, the seller 120 is able to select the content for content-based advertisements. For example, the seller 120 may select a URL, a Twitter feed, an RSS feed, a Facebook page, or any other online feed or page, whether static or dynamic. Preferably, the content is not a direct sales link, but the content will favorably increase the user's interest in the seller's goods or services. In one embodiment, an application on the seller's computer or even an applet in the seller's browser is used to mark the content for use in a digital advertisement.

In some embodiments, the self-service user interface 200 enables seller 120 to compose advertisements using ad canvases and the intelligent content scraper. For example, the self-service user interface 200 may enable the seller 120 to select one or more ad sizes to be filled with content gathered by the intelligent content scraper, which parses online content to find relevant graphics, pictures, and/or text for a digital advertisement. As previously noted, the digital advertisements may be for online use of offline use. For example, the digital advertisement may be a 300×250 pixel banner advertisement, a mobile advertisement (i.e., for display in a mobile device application or web browser), a text or partial text advertisement, a social media advertisement (e.g., with Facebook, Linkedin, or Twitter content), or a sponsored story advertisement.

In some embodiments, the intelligent content scraper selects an image from the content and resizes the image to fit one or more ad canvases. Additionally or alternatively, the intelligent content scraper selects text from the content and places the text inside one or more ad canvases. The intelligent content scraper may optionally add visible metadata related to the content of an advertisement. The visible metadata may correspond to social media information, such as the number of Facebook likes (Facebook sharecount API) or Pinterest pins, Twitter followers, the number of the consumer's friends who have tagged the content using social timing information (e.g., when a story was first published), the number or comments, or other visible metadata. According to various embodiments, there may be two, three, four, five, or any number of versions of a digital advertisement, i.e., any number of creatives. Each creative may vary in different ways, including size, text, image, resolution, social media links, visible metadata, etc.

In some embodiments, the intelligent content scraper uses one or more rules to identify the best image from the content 120. The rules may include where the image is located on the page, the aspect ratio of the image, and where the image is in relation to the text on the page. Machine learning is preferably used to optimize the decision-making abilities of the intelligent content scraper. Without limitation, the machine learning may correspond to a supervised machine learning algorithm such as a backward error propagation algorithm, a neural network algorithm, a support vector machine algorithm, a random forest algorithm, or a naive Bayes algorithm. The intelligent content scraper also looks at such information as header tags, text in the title of the article, repeated words in the text, and the actual URL of the page to determine text for the digital advertisement. The source of the content may be identified by the source, the page title for the base URL, or domain.

The seller 120 also may use the self-service user interface 200 to provide or reference a budget and payment information. The budget may be a fixed amount or an amount to be spent over a given time period (e.g., $10,000/week) on content-based advertising. Once at least one creative is generated and selected and the budget is set, the advertisement and budget are uploaded to an ad exchange or advertisement congregator 160. Currently, the advertisement congregator 160 may take as much as twenty-four (24) hours to approve each submitted advertisement, Note that the advertisement congregator 160 may also act as the bidder 180, using the same or different servers for each function. In other embodiments, the advertisement congregator 160 and the bidder 180 are separate entities, using separate servers. When the advertisement congregator 160 and the bidder 180 are separate, the seller sends budget information to the bidder 180 instead of to the advertisement congregator 160. In some embodiments, a demand-side platform performs most bidding on online advertisements.

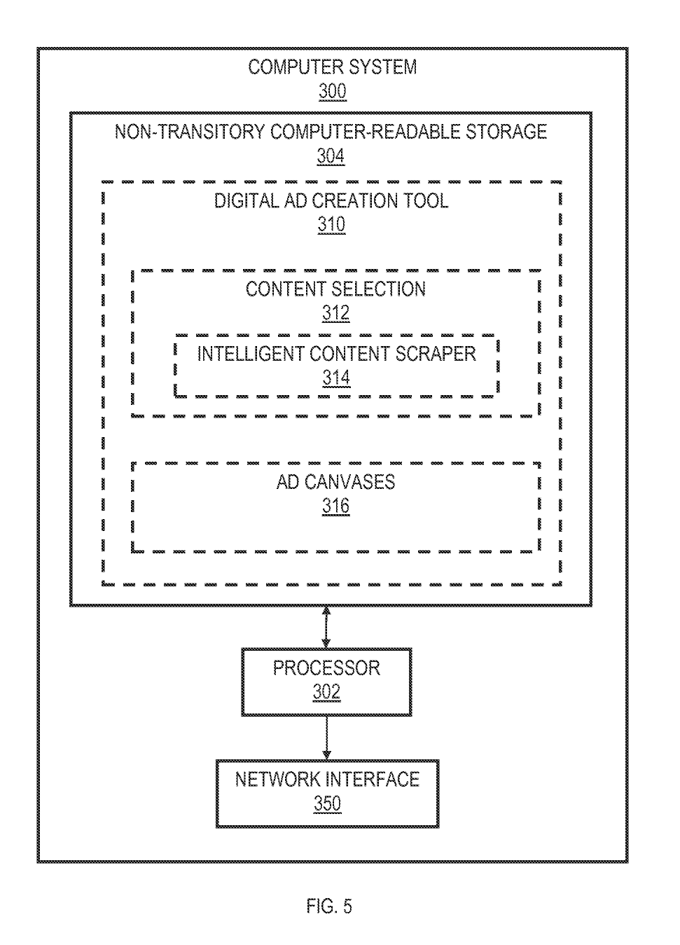

FIG. 5 shows an illustrative computer system 300. The computer system 300 may correspond to an information system owned and operated by an advertiser 140. As shown, the computer system 300 comprises a processor 302 coupled to a non-transitory computer readable storage 304 storing a digital ad creation tool or software 310 with content selection features 312 including an intelligent content scraper 314 as described herein. As shown, the computer system 300 also comprises a network interface 350 coupled to the processor 302 to communicate with other servers or clients of a networked computer system (e.g., system 200 of FIG. 3).

In at least some embodiments, the digital ad creation tool 310, when executed, causes the processor 302 to automatically store in memory (e.g., the non-transitory computer-readable storage 304 or other memory) one or more digital advertisements by processing a provided document to derive a length of text associated with the document, where each of the one or more digital advertisements includes at least the derived length of text. The digital ad creation tool 310, when executed, may further cause the processor 302 to store in memory one or more digital advertisements by processing the provided document to derive at least one image associated with the document and the length of text associated with the document where each of the one or more digital advertisements includes at least one composite of a derived image and derived length of text. The digital ad creation tool 310, when executed, also may cause the processor 302 to direct the network interface 350 to retrieve a document associated with a provided URL. The network interface 350 also may send created digital advertisements to an ad exchange as soon as the processor 302 automatically stores in memory the one or more digital advertisements.

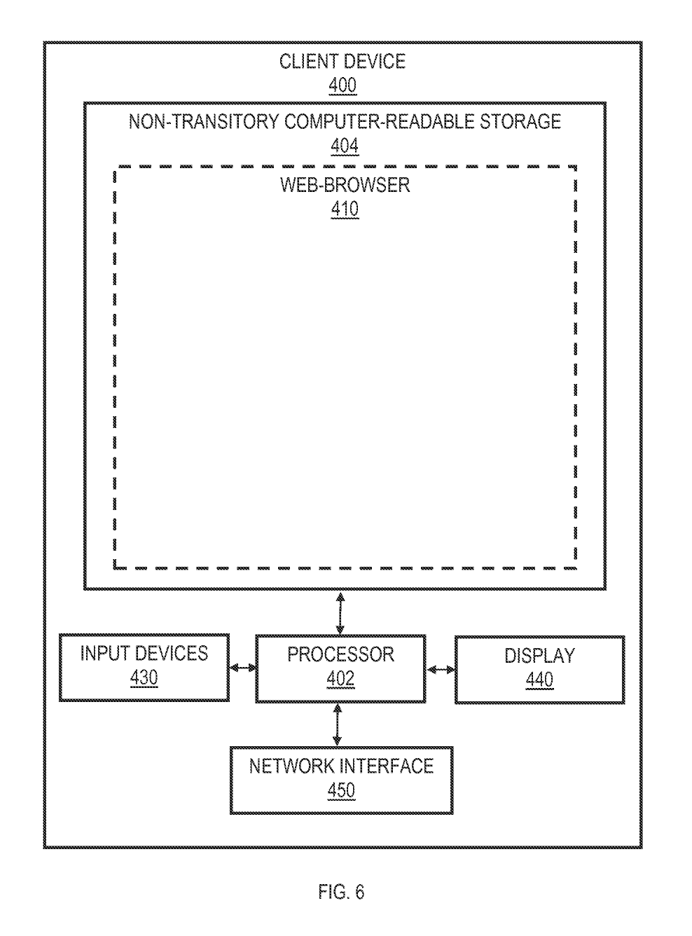

FIG. 6 shows an illustrative client device 400 in accordance with an example of the disclosure. The client device 400 may correspond, for example, to a computer employed by consumer 150 to access web pages, or a computer employed by seller 120 to access the self-service user interface 212. As shown, the client device 400 comprises a processor 402 coupled to a non-transitory computer readable storage 404 storing a web browser 410. The client device 400 also comprises input devices 430, a display 440, and a network interface 450 coupled to the processor 402.

The client device 400 is representative of a smartphone, a cellular phone, a personal digital assistant (PDA), a tablet computer, a laptop computer, a desktop computer or other computing device configured to communicate with a server to access online content or services. The processor 402 is configured to execute instructions read from the non-transitory computer readable storage 402.

In some examples, the non-transitory computer readable storage 404 corresponds to random access memory (RAM), which stores programs and/or data structures during runtime of the client device 400. For example, during runtime of the client device 400, the non-transitory computer readable storage 404 may store web browser 410 for execution by the processor 402 to access online content or services.

The input devices 430 may comprise various types of input devices for selection of data or for inputting of data to the client device 400. As an example, the input devices 430 may correspond to a touch screen, a key pad, a keyboard, a cursor controller, or other input devices.

The network interface 450 may couple to the processor 402 to enable the processor 402 to communicate with network servers to access online content or services. For example, the network interface 450 may enable the client device 400 to receive information from and/or to send information to seller 120, advertiser, 140, congregator 160, page server 160, and/or bidder 180.

In different embodiments, the network interface 450 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. The network interface 450 may enable the processor 402 to communicate with the Internet or one or more intranets. With such a network connection, it is contemplated that the processor 402 might receive information from the network, or might output information to the network in the course of performing the consumer actions or seller actions described herein.

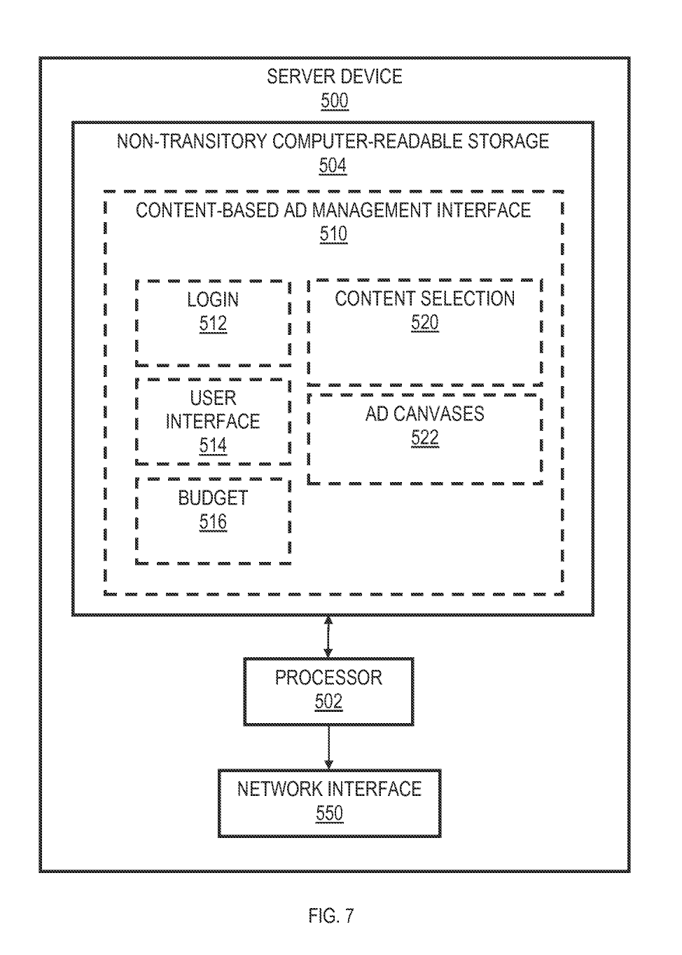

FIG. 7 shows a server device 500 in accordance with an embodiment of the disclosure. The server device 500 may provide the self-service user interface 212 and/or the digital ad creation tool operations described for FIGS. 4 and 5, and may be owned and operated by advertiser 140. As shown, the server device 500 comprises a processor 502 and a non-transitory computer-readable storage 504 that stores a content-based ad management application 510. The processor 502 also couples to a network interface 550 that enables network communications as described herein. The processor 502, the non-transitory computer-readable storage 504, and network interface 550 may implement various hardware, security, storage, and communication protocols as would be understood by one of ordinary skill in the art.

In accordance with at least some embodiments, the content-based ad management application 510 comprises a login module 512, a user interface module 514, a budget module 516, a content selection module 520, and ad canvases module 522. The login module 512 manages login features related to the self-service user interface 212 described herein. The user interface module 514 stores instructions and/or data to direct presentation of the self-service user interface 212. The budget module 516 manages budget and payment options related to the self-service user interface 212. The content selection module 520 manages the content selection options related to the self-service user interface 212. The ad canvases module 522 manages the ad canvas options related to the self-service user interface 212.

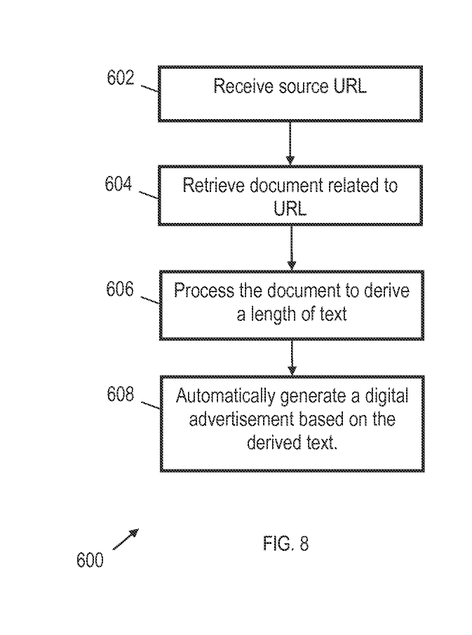

FIG. 8 shows a flowchart thr a digital advertisement creation method 600. In some embodiments, the method 600 may be performed by a computer system (e.g., system 300) or server device (e.g., device 500) owned and operated by advertiser 140. As shown, the method includes receiving a source URL (block 602), At block 604, a document related to the URL is retrieved. At block 606, the document is processed to derive a length of text. At block 608, a digital advertisement (e.g., an online display advertisement or banner ad) is automatically generated based on the derived text.

In some embodiments, the processing step of block 606 includes deriving at least an image associated with the document and the length of text associated with the document. In such case, the generating step of block 608 may include automatically generating the digital advertisement from at least the derived image and the derived length of text. Further, in some embodiments, the processing step of claim 606 may include identifying a main image associated with the document, identifying a headline associated with the document, and/or identifying a source associated with the document.

As an example headline identification process, a text string associated with a meta tag named “title” may be identified as the headline. In another headline identification example process, text strings shorter than a predetermined minimum length or longer than a predetermined maximum length are ignored unless all possible choices are eliminated by the remaining tests of the rule. Further, text from a meta tag named “title” may be accepted as the headline unless an indication of truncation exists. If a sentence in the document starts with the truncated text from the meta tag named “title”, then the sentence text may be accepted as the headline. Further, a Levenshtein distance between a stripped version of the document and each separate text string in the document may be evaluated, and the text with shortest length with shortest Levenshtein distance if the headline would be less than a predetermined fraction of the length of a stripped text from the meta tag named “title” may be accepted as the headline. If all else fails, text from a meta tag named “metatitle” may be accepted as the headline. If “metatitle” does not exist, text from a meta tag named “description” may be accepted as the headline. If “description” does not exist, any available text from the meta tag named “title” may be accepted as the headline.

In some embodiments, the headline identification process includes the following steps: 1) ignoring text strings shorter than 10 or longer than 140 characters unless all possible choices are eliminated by this rule; 2) accepting text from a meta tag named “title” as the headline unless an indication of truncation exists; 3) if a sentence in the document starts with the truncated text from the meta tag named “title”, then accepting the sentence text as the headline; 4) evaluating a Levenshtein distance between a stripped version of the document and each separate text string in the document, and accepting as the headline the text with shortest length with shortest Levenshtein distance if the headline would be less than 40% of the length of a stripped text from the meta tag named “title”; 5) if steps 1-4 do not result in a headline, accepting as the headline text from a meta tag named “metatitle”; 6) if steps 1-5 do not result in a headline and “metatitle” does not exist, accepting as the headline text from a meta tag named “description”; and 7) if steps 1-6 do not result in a headline and “description” does not exist, accepting any text from the meta tag named “title”.

As an example main image identification process, all images in the document may be analyzed, and the main image is chosen using a machine-learning algorithm (e.g., a naïve Bayes machine-learning algorithm). The machine-learning algorithm may identify the main image by evaluating two or more various features, such as image height, image width, image aspect ratio, number of occurrences in the document, type of image tag, image location by depth order in the document tree, image location relative to total text in the document, ent, length of image shortest edge, image size, image link type, and/or image URL. In other embodiments, three or more features may be used. In still other embodiments, ten or more features may be used.

In some embodiments, identifying the source includes identifying a base host name for the document from the base URL and the text from the meta tag named “title” may be identified as the source. In some embodiments, the generating step of 608 may include generating the digital advertisement from the identified main image, the derived length of text, and an indication of the source of the source URL.

In some embodiments, the method 600 may include additional or alternative steps. For example, the method 600 may additionally include sending the digital advertisement to an ad exchange network. Further, the method 600 may additionally include evaluating the validity of the source URL prior to retrieving the document associated with the source URL. Further, the method 600 may additionally include normalizing the source URL prior to retrieving the document associated with the source URL. Further, the method 600 may additionally include editing one or more of the derived image and the derived length of text. Further, the method 600 may additionally include retrieving one or more social media values or other visible metadata, and including at least an indication of the visible metadata when automatically generating the digital advertisement. In some embodiments, visible metadata such as timing information or social media values (e.g., Facebook likes or Twitter shares) is associated with the document associated with the source URL.

FIG. 7 shows an example of various components of a computer system 700 in accordance with the disclosure. The computer system 700 may perform various operations to support the automatic generation of digital advertisements as described herein. The computer system 700 may correspond to components of page server 170, ad creation server 210, ad storing server 220, content providing server 230, ad creator server 240, source server 250, social media server 260, ad exchange server 270, consumer computer 202, computer system 300, client device 400, or server device 500.

As shown, the computer system 700 includes a processor 702 (which may be referred to as a central processor unit or CPU) that is in communication with memory devices including secondary storage 704, read only memory (ROM) 706, random access memory (RAM) 708, input/output (I/O) devices 710, and network connectivity devices 712. The processor 702 may be implemented as one or ore CPU chips.

It is understood that by programming and/or loading executable instructions onto the computer system 700, at least one of the CPU 702, the RAM 708, and the ROM 706 are changed, transforming the computer system 700 in part into a particular machine or apparatus having the novel functionality taught by the present disclosure. In the electrical engineering and software engineering arts functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in slating from the software domain to the hardware domain. For example, a design that is still subject to frequent change may be implemented in software, because re-spinning a hardware implementation is more expensive than re-spinning a software design. Meanwhile, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 704 may be comprised of one or more disk drives or tape drives and is used for non-volatile storage of data and as an over-flow data storage device if RAM 708 is not large enough to hold all working data. Secondary storage 704 may be used to store programs which are loaded into RAM 708 when such programs are selected for execution. The ROM 706 is used to store instructions and perhaps data which are read during program execution. ROM 706 is a non-volatile memory device which typically has a small memory capacity relative to the larger memory capacity of secondary storage 704. The RAM 708 is used to store volatile data and perhaps to store instructions. Access to both ROM 706 and RAM 708 is typically faster than to secondary storage 704. The secondary storage 704, the RAM 708, and/or the ROM 706 may be referred to in some contexts as computer readable storage media and/or non-transitory computer readable media.

I/O devices 710 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 712 may take the form of moderns, modern banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 712 may enable the processor 702 to communicate with the Internet or one or more intranets. With such a network connection, it is contemplated that the processor 702 might receive information from the network, or might output information to the network in the course of performing the above-described method steps. Such information, which is often represented as a sequence of instructions to be executed using processor 702, may be received from and outputted to the network, for example, in the form of a computer data signal embodied in a carrier wave.

Such information, which may include data or instructions to be executed using processor 702 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods known to one skilled in the art. The baseband signal and/or signal embedded in the carrier wave may be referred to in some contexts as a transitory signal.

The processor 702 executes instructions, codes, computer programs, scripts which it accesses from hard disk, floppy disk, optical disk (these various disk based systems may all be considered secondary storage 704), ROM 706, RAM 708, or the network connectivity devices 712. While only one processor 702 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 704, for example, hard drives, floppy disks, optical disks, and/or other device, the ROM 706, and/or the RAM 708 may be referred to in some contexts as non-transitory instructions and/or non-transitory information.

In an embodiment, the computer system 700 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 700 to provide the functionality of a number of servers that is not directly bound to the number of computers in the computer system 700. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the automatic generation of digital advertisements described herein may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in movable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others, The computer program product may be suitable for loading, by the computer system 700, at least portions of the contents of the computer program product to the secondary storage 704, to the ROM 706, to the RAM 708, and/or to other non-volatile memory and volatile memory of the computer system 700. The processor 702 may process the executable instructions and/or data structures in part by directly accessing the computer program product, for example by reading from a CD-ROM disk inserted into a disk drive peripheral of the computer system 700. Alternatively, the processor 702 may process the executable instructions and/or data structures by remotely accessing the computer program product, for example by downloading the executable instructions and/or data structures from a remote server through the network connectivity devices 712. The computer program product may comprise instructions that promote the loading and/or copying of data, data structures, files, and/or executable instructions to the secondary storage 704, to the ROM 706, to the RAM 708, and/or to other non-volatile memory and volatile memory of the computer system 700.

In some contexts, the secondary storage 704, the ROM 706, and the RAM 708 may be referred to as a non-transitory computer readable medium or a computer readable storage media. A dynamic RAM embodiment of the RAM 708, likewise, may be referred to as a non-transitory computer readable medium in that while the dynamic RAM receives electrical power and is operated in accordance with its design, for example during a period of time during which the computer 700 is turned on and operational, the dynamic RAM stores information that is written to it. Similarly, the processor 702 may comprise an internal RAM, an internal ROM, a cache memory, and/or other internal non-transitory storage blocks, sections, or components that may be referred to in some contexts as non-transitory computer readable media or computer readable storage media.

Numerous modifications, equivalents, and alternatives will become apparent to those skilled in the art once the above disclosure is fully appreciated. It is intended that the following claims be interpreted (where applicable) to embrace all such modifications, equivalents, and alternatives.

What is claimed is:

1. A method for automatically generating a digital advertisement, the method comprising:
receiving a source uniform resource locator (URL);
retrieving a document associated with the source URL;
processing the document associated with the source URL to derive at least a length of text associated with the document; and
automatically generating a digital advertisement from at least the length of text.

2. The method of claim 1, further comprising:
evaluating the validity of the source URL prior to said retrieving the document associated with the source URL.

3. The method of claim 1, further comprising:
normalizing the source URL prior to said retrieving the document associated with the source URL.

4. The method of claim 1, wherein said processing the document associated with the source URL comprises processing the document associated with the source URL to derive at least an image associated with the document and the length of text associated with the document; and
wherein said automatically generating the digital advertisement comprises automatically generating the digital advertisement from at least the image and the length of text.

5. The method of claim 4, wherein said processing the document associated with the source URL to derive at least the image associated with the document and the length of text associated with the document further comprises:
identifying a main image associated with the document.

6. The method of claim 5, wherein said processing the document associated with the source URL to derive at least the image associated with the document and the length of text associated with the document further comprises:
identifying a headline associated with the document.

7. The method of claim 6, wherein said processing the document associated with the source URL to derive at least the image associated with the document and the length of text associated with the document further comprises:
identifying a source associated with the document.

8. The method of claim 5, wherein said identifying the main image associated with the document further comprises:
identifying all images in the document; and
choosing the main image from all the images using a machine learning algorithm.

9. The method of claim 8, wherein the machine learning algorithm is a supervised machine learning algorithm.

10. The method of claim 8, wherein the machine learning algorithm evaluates at least two or more items taken from the group consisting of image height, image width, image aspect ratio, number of occurrences in the document, type of image tag, image location by depth order in the document tree, image location relative to total text in the document, length of image shortest edge, image size, image link type, and image URL.

11. The method of claim 4, wherein said processing the document associated with the source URL to derive at least the image associated with the document and the length of text associated with the document further comprises:
identifying a headline associated with the document.

12. The method of claim 11, wherein said identifying the headline associated with the document further comprises selecting a text string associated with a meta tag named “title”.

13. The method of claim 4, wherein said processing the document associated with the source URL to derive at least the image associated with the document and the length of text associated with the document further comprises:
identifying a source associated with the document.

14. The method of claim 12, wherein said identifying the source associated with the document further comprises:
identifying a base host name for the document from the base URL and the text from the meta tag named “title”.

15. The method of claim 4, further comprising:
editing one or more of the image and the length of text.

16. The method of claim 4, wherein said automatically generating the digital advertisement from at least the image and the length of text further comprises automatically generating the digital advertisement from the image, the length of text, and an indication of the source of the source URL.

17. The method of claim 1, further comprising:
retrieving visible metadata related to content of the digital advertisement; and
including at least an indication of the visible metadata during said automatically generating the digital advertisement.

18. The method of claim 17, wherein the visible metadata is a social media value.

19. The method of claim 18, wherein the social media value is a value selected from the group consisting of a number of Facebook likes, a number of Twitter shares, a number of Pinterest pins, a number of comments, and a number of friend tags.

20. The method of claim 17, wherein the visible metadata is selected from the group consisting of related document information and timing information.

21. The method of claim 1, further comprising:
sending the digital advertisement to an ad exchange network.

22. The method of claim 1, wherein the digital advertisement comprises an online display advertisement.

23. An information system for automatically creating digital advertisements, the information system comprising:
a memory storing digital ad creation software; and
at least one processor operatively coupled to the memory, wherein when the at least one processor runs the digital ad creation software, the at least one processor automatically stores in the memory one or more digital advertisements by processing a provided document to derive a length of text associated with the document, wherein each of the one or more digital advertisements includes at least the length of text.

24. The information system of claim 23, wherein the at least one processor automatically stores in the memory the one or more digital advertisements by processing the provided document further comprises by processing the provided document to derive at least one image associated with the document and the length of text associated with the document, wherein each of the one or more digital advertisements further includes at least one composite of the at least one image and the length of text.

25. The information system of claim 23, further comprising:
a network interface operatively coupled to the memory and the at least one processor, wherein when the at least one processor runs the digital ad creation software, the network interface retrieves the document associated with a provided URL for the at least one processor.

26. The information system of claim 25, wherein the network interface is further configured to send a digital advertisement to an ad exchange as early as when the at least one processor automatically stores in the memory the one or more digital advertisements.

27. A networked computer system for automatically generating a digital advertisement, the computer system comprising:
an ad creation server that automatically creates a digital advertisement based on a source document;
an ad storing server that provides at least an indication of the digital advertisement in response to a request for the at least one digital advertisement; and
a content providing server that stores a page configured to be requested over a network, wherein the page includes a location for integrating a display of a selected advertisement in response to a request for the page over the network;
wherein the ad storing server further provides the at least the indication of the at least one digital advertisement in response to the request for the page.

28. The networked computer system of claim 27, further comprising:
an ad creator server that transmits a source URL for the source document to the ad creation server.

29. The networked computer system of claim 27, further comprising:
a source server that transmits the source document to the ad creation server in response to receiving a request at the source URL.

30. The networked computer system of claim 27, further comprising:
a social media server that transmits the indication of the social media popularity for the source page in response to a request from the ad creation server.

31. The networked computer system of claim 27, further comprising:
an ad exchange server that selects a winning advertisement and transmits the winning advertisement as the selected advertisement in response to the request for the page.
